(19) United States
(12) Patent Application Publication
(10) Pub. No.: US 2022/0194495 A1
(43) Pub. Date: Jun. 23, 2022

(54) BOLT-ON FLAT IDLER SEGMENTS

(71) Applicant: Caterpillar Inc., Peoria, IL (US)

(72) Inventors: Kevin L. Steiner, Tremont, IL (US); Donovan Stuart Clarke, East Peoria, IL (US); Robert Donald Bierman, Peoria, IL (US); Eric B. Weisbruch, Edwards, IL (US); Jason L. Sebright, Chillicothe, IL (US); Martin Tagore Joseph Xavier, Thirumulivoyal (IN); Daniel I. Knobloch, Morton, IL (US); Philip Steffen Ricketts, Hanna City, IL (US)

(73) Assignee: Caterpillar Inc., Peoria, IL (US)

(21) Appl. No.: 17/128,607

(22) Filed: Dec. 21, 2020

(51) Int. Cl. B62D 55/14

(52) U.S. Cl. CPC B62D 55/145

(57) ABSTRACT

An idler assembly includes a cylindrical hub defining an axis of rotation, a radial direction, and a circumferential direction. A stepped circumferential surface of the cylindrical hub has a first radially inner face, and a radially outer cylindrical face. Mounting holes extend radially into the radially outer cylindrical face. A first idler segment is attached to the cylindrical hub, and includes an at least partially flat body having a first planar chain link contacting surface. The cylindrical hub has a first set of metallurgical properties that is different than the second set of metallurgical properties of the first idler segment.

### TECHNICAL FIELD

The present disclosure relates to an idler used to guide a track chain assembly of an endless undercarriage drive employed by earth moving, construction and mining equipment and the like. Specifically, the present disclosure relates to such an idler that is assembled using idler segments that may decrease the likelihood of scalloping developing on the links of the track chain assembly.

### BACKGROUND

Earth moving, construction and mining equipment and the like are often used in rough, off-road terrain. These machines often employ an endless drive with track shoes that is better able to propel the machines in such environments over obstacles and uneven terrain, etc. The track chain assemblies, which include shoes, are held together by a series of interconnected track links, pins and bushings that are supported on the drive sprocket, idler and support rollers of the machine. The drive sprocket, is so called, as it may drive or convey power to the track chain assembly, causing it to revolve about the idler wheels, resulting in linear motion of the machine. The idler wheels provide guidance to the track chain assembly, helping to keep the track chain assembly on the undercarriage.

Heavy loads are often exerted on the idler, which is typically round, that contacts the flat surfaces of the links of the track chain assembly. Over time, scalloping may occur on the links of the track chain assembly at the interface between the round idler and the links. This scalloping may cause an uneven ride and eventually results in unwanted maintenance and downtime for the machine.

For example, the links and/or track chain assembly as a whole may need to be replaced or repaired.

### SUMMARY

An idler assembly according to an embodiment of the present disclosure may comprise a cylindrical hub defining an axis of rotation, a radial direction, and a circumferential direction, and may include a stepped circumferential surface having a first radially inner face, and a radially outer cylindrical face. A plurality of mounting holes may extend radially into the radially outer cylindrical face. The idler assembly may also have a first idler segment including an at least partially flat body having a first planar chain link contacting surface. The cylindrical hub may have a first set of metallurgical properties that is different than the second set of metallurgical properties of the first idler segment.

An idler segment according to an embodiment of the present disclosure may comprise an at least partial flat body including defining a longitudinal direction, a lateral direction that is perpendicular to the longitudinal direction, and a vertical direction that is perpendicular to the lateral direction and the vertical direction. The body may further define a first longitudinal end, a second longitudinal end, a first lateral end, a second lateral end, a first vertical extremity, and a second vertical extremity. A first flat rail surface may extend laterally from the first lateral end toward the second lateral end, while a second flat rail surface may extend laterally from the second lateral end toward the first lateral end. A guide ridge may laterally connect the first flat rail surface to the second flat rail surface.

An idler segment according to another embodiment of the present disclosure may comprise an at least a partial body of revolution including defining a circumferential direction, a radial direction, and an axis of rotation. A guide ridge may extend axially, radially, and circumferentially, while a first planar contact surface may extend axially from the guide ridge on one side and a second planar contact surface may extending axially from the guide ridge on the other side. The first planar contact surface may comprise a first material zone with a first property, and a remaining portion of the at least partial body of revolution comprises a second material zone with a second property that is different than the first property.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a side-view of a machine such a bull dozer that may use flat idler segments in its undercarriage according to various embodiments of the present disclosure.

FIG. 2 is a front view of an idler assembly with flat idler segments that may be used in the undercarriage of the machine of FIG. 1.

FIG. 3 is a perspective view of an idler assembly with flat idler segments similar to that shown in FIG. 2 shown in isolation.

FIG. 4 is an enlarged detail view of the idler assembly of FIG. 3, showing the flat rail surfaces of the idler segments more clearly.

FIG. 5 is a side cross-sectional view of the idler assembly of FIG. 3.

FIG. 6 is a perspective view of the flat idler segment of FIG. 4 shown in isolation.

FIG. 7 is a perspective view of a flat idler segment that is identical to that of FIG. 6 except the underside surfaces are planar instead of arcuate.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

An undercarriage assembly that may use an idler assembly or an idler segment according to various embodiments of the present disclosure will now be described.

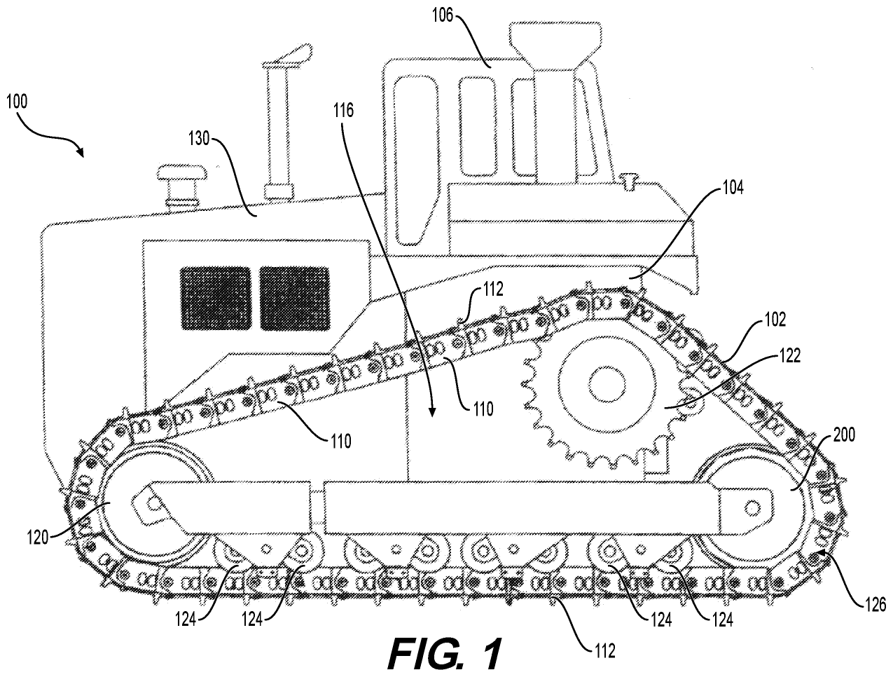

FIG. 1 shows an embodiment of a tracked machine 100 in the form of a bull dozer that includes an embodiment of an idler assembly 200 constructed in accordance with principles of the present disclosure. Among other uses, a bull dozer can be used to push dirt and rocks in various surface earth moving and construction applications.

While the arrangement is illustrated in connection with a bull dozer, the arrangement disclosed herein has universal applicability in various other types of machines commonly employ track systems, as opposed to wheels. The term “machine” may refer to any machine that performs some type of operation associated with an industry such as mining, earth moving or construction, or any other industry known in the art. For example, the machine may be an excavator, a wheel loader, a cable shovel, a track type tractor, a hydraulic mining shovel, or dragline or the like. Moreover, one or more implements may be connected to the machine. Such implements may be utilized for a variety of tasks, including, for example, lifting and loading.

As shown in FIG. 1, the machine 100 may include a body 104, with a track system 102 attached thereto, and also has a cab 106 to house a machine operator. The machine may also include an implement such as a blade or a bucket, etc. (not shown). A control system can be housed in the cab 106 that can be adapted to allow a machine operator to manipulate and articulate the implement 110 for digging, excavating, or any other suitable application.

Its undercarriage structure includes a supporting structure that supports the track system 102 utilized for movement of the machine 100. The track system 102 may include first and second track roller frame assemblies 116, which are spaced from and adjacent respective first and second sides of the undercarriage assembly. It will be appreciated that only one of the track roller frame assemblies 116 is visible in FIG. 1.

Each of the track roller frame assemblies 116 carries a front idler wheel 120, a drive sprocket assembly 122, and a plurality of track guiding rollers 124. The drive sprocket assembly 122, is powered in forward and reverse directions by the machine 100. An endless track chain assembly 126 encircles each drive sprocket assembly 122, the front idler wheel 128, rear idler wheel assembly (e.g., see 200) and the track guiding rollers 124. The track chain assembly 126 includes a plurality of interconnected track links 110 and track shoes 112. The track guiding rollers 124 and idlers 120, 200 guide the track links 110 as the track chain assembly 126 is driven by the drive sprocket wheel assembly 122. The track chain assembly 126 may have any track chain member, track pin retention device, and/or track chain assembly. A power source 130 supplies the power to drive the track chain assembly 126 via the sprocket assembly 122, as the lugs of the drive sprocket assembly 122 engage the various track bushings (not shown in FIG. 1), propelling the movement of the track chain assembly 126 as described earlier herein.

Power source 130 may drive the sprocket assembly 122 of machine 100 at a range of output speeds and torques. Power source 130 may be an engine such as, for example, a diesel engine, a gasoline engine, a gaseous fuel-powered engine, or any other suitable engine. Power source 130 may also be a non-combustion source of power such as, for example, a fuel cell, a power storage device, or any other source of power known or that will be devised in the art.

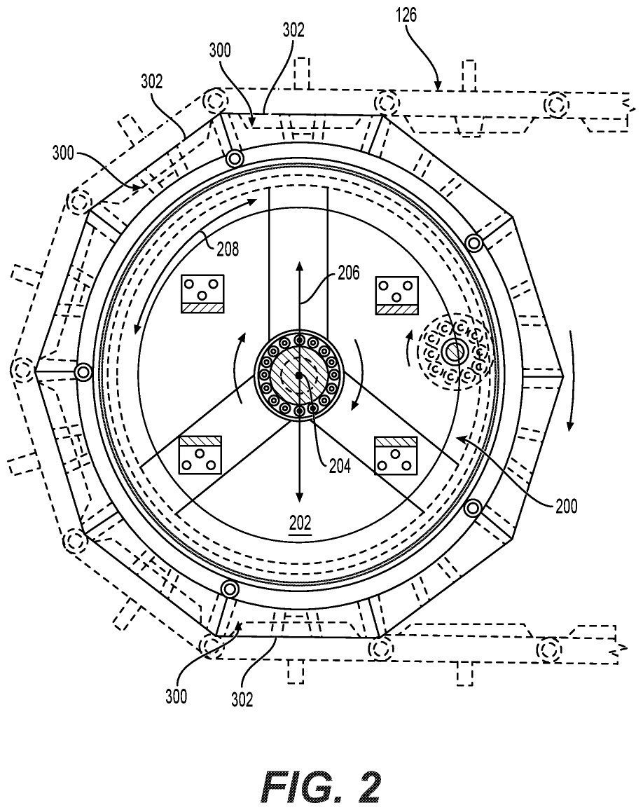

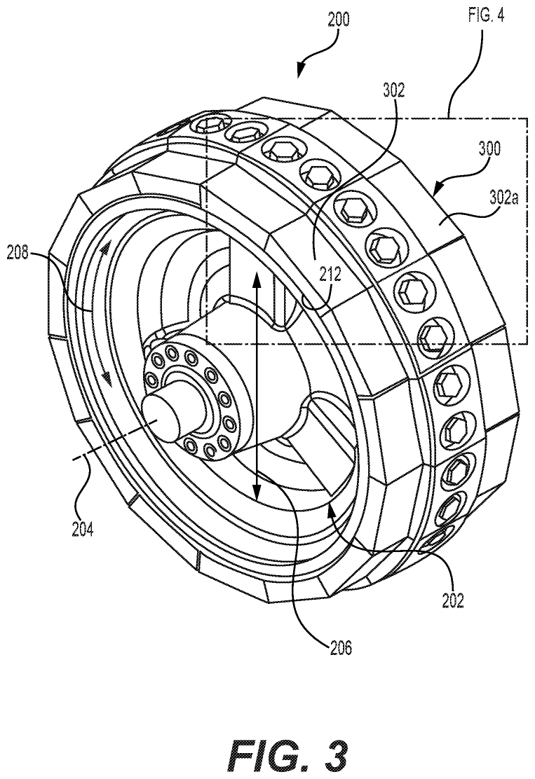

Turning now to FIGS. 2 and 3, detail of the idler assembly 200 according to an embodiment of the present disclosure will now be discussed.

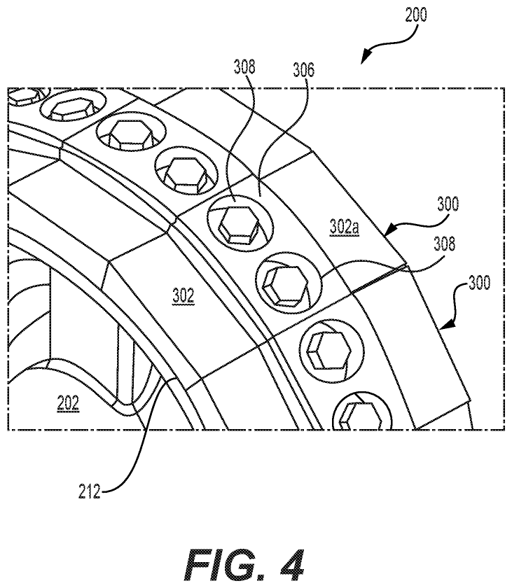

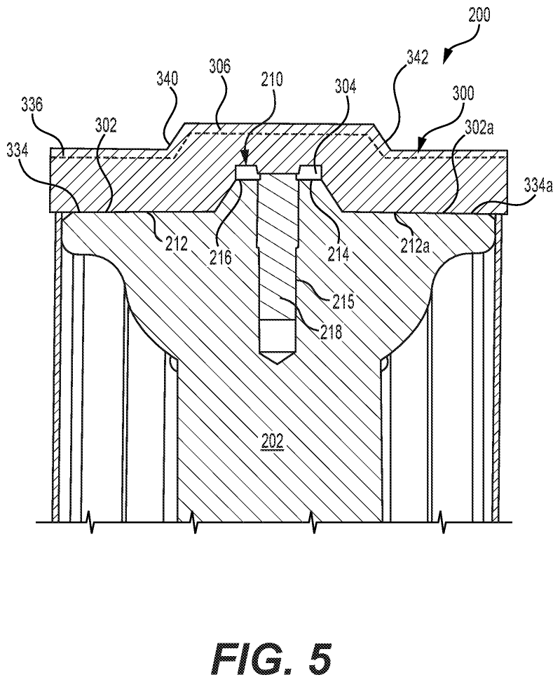

An idler assembly 200 may comprise a cylindrical hub 202 defining an axis of rotation 204, a radial direction 206, and a circumferential direction 208. As best seen in FIG. 5, the cylindrical hub 202 may include a stepped circumferential surface 210 having a first radially inner face 212, and a radially outer cylindrical face 214. A plurality of mounting holes 215 may extend radially into the radially outer cylindrical face 214. A first idler segment 300 may be attached to the cylindrical hub 202 and may have an at least partially flat body having a first planar chain link contacting surface 302 as best seen in FIGS. 2 and 4.

The cylindrical hub 202 may have a first set of metallurgical properties that is different than a second set of metallurgical properties of the first idler segment.

More particularly, there may be a difference between the first set of metallurgical properties of the cylindrical hub 202, and the second set of metallurgical properties of the first idler segment 300 that includes at least one of the following: a material composition, a hardness, a coating, or a distribution of the material composition, the hardness, or the coating.

In some embodiments of the present disclosure, the first idler segment 300 has a different material composition than the cylindrical hub 202. For example, the first idler segment 300 may be made from steel while the cylindrical hub 202 may be made from iron, grey-cast iron, etc. Or, the first idler segment may be at least partially hardened to a higher hardness than the cylindrical hub. Or, a coating may be applied to the first planar chain link contacting surface to increase hardness and/or reduce wear. This coating may be omitted from the cylindrical hub. Any combination of these differences may be employed, etc.

Focusing on the geometry shown in FIG. 5, it may be understood that the stepped circumferential surface 210 may form a spline 216, while the first idler segment 300 may define a spline receiving groove 304. When the spline 216 of the cylindrical hub 202 is disposed in the spline receiving groove 304 of the first idler segment 300, axial support is provided so that lateral loads exerted by the links of the track chain assembly in use are not borne solely by the fasteners 218 (e.g., bolts, cap screws, etc.). These lateral loads may be transmitted to the first idler segment 300 through its guiding ridge that 306 that may contact the insides of the links of the track chain assembly as the track chain assembly shifts laterally as the machine 100 is used.

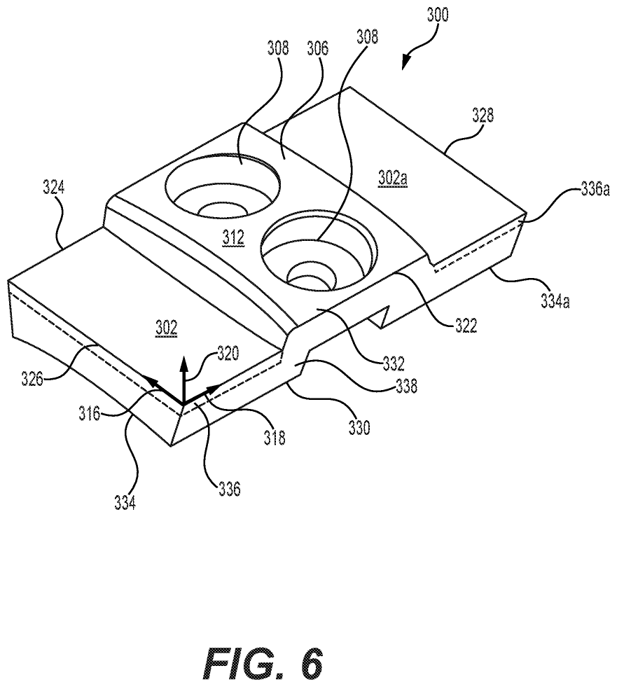

As best seen in FIGS. 4 and 6, a plurality of mounting apertures 308 extend radially through the first idler segment 300 (e.g., through the guiding ridge 306 as shown, but not necessarily so), and are aligned circumferentially, and axially with the plurality of mounting holes 215 of the cylindrical hub. This allows the fasteners 218 to attach the first idler segment 300 to the cylindrical hub 202 in a robust manner.

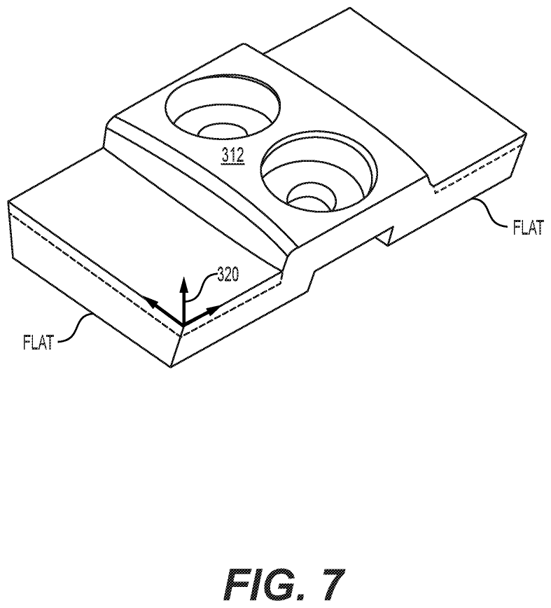

Looking at FIGS. 3 thru 5, it can be seen that the first radially inner face 212 of the cylindrical hub may be a convex arcuate surface unlike the first planar chain link contacting surface 302 of the first idler segment 300. However, it is contemplated that the first radially inner face 212 may be a flat or a planar surface in other embodiments of the present disclosure that would mate with the flat underside surfaces of the idler segment shown in FIG. 7 for example. In such a case, the radially inner face would be faceted around the perimeter to mate with a plurality of such idler segments.

Similarly, the stepped circumferential surface 210 of the cylindrical hub 202 may include a second radially inner face 212a (see FIG. 5), and the first idler segment 300 may include a second planar chain link contacting surface 302a that is in a plane (i.e., the same geometric plane, see also FIG. 6) with the first planar chain link contacting surface 302. This may not be the case for other embodiments of the present disclosure. The second radially inner face 212a of the cylindrical hub 202 may be a convex arcuate surface that is coextensive with the first radially inner face 212 (i.e., this surface would be continuous if not interrupted by the guiding ridge). In the other embodiments, both these surfaces 212 and 212a may be in the same flat plane. Also, both surfaces 212, 212a may be faceted and synchronized circumferentially with each other to mate with the idler segment shown in FIG. 7 in other embodiments of the present disclosure.

As can be best understood by looking at FIGS. 2 and 3 together, a plurality of idler segments that are identically configured as the first idler segment 300 may be provided as a circular array about the axis of rotation 204. Their circumferential ends may be adjacent each other so that circumferential loads exerted on these segments will be shared by the circumferentially adjacent segments, helping to prevent over loading of the fasteners 218. Likewise, the first and the second radially inner faces 212, 212 may be concentric with the radially outer cylindrical face 214, providing the desired support for the idler segments. This may not be the case for other embodiments of the present disclosure.

Next, an idler segment that may be used to assemble the idler assembly 200 as just described herein, or as a replacement part will now be described with reference to FIGS. 5 and 6.

Starting with FIG. 6, such an idler segment 300 may comprise an at least partial flat body including defining a longitudinal direction 316, a lateral direction 318 that is perpendicular to the longitudinal direction 316, and a vertical direction 320 that is perpendicular to the lateral direction 318 and the vertical direction. The body may further define a first longitudinal end 322, a second longitudinal end 324, a first lateral end 326, a second lateral end 328, a first vertical extremity 330, and a second vertical extremity 332.

A first flat rail surface (e.g., see 302) may extend laterally from the first lateral end 326 toward the second lateral end 328, while a second flat rail surface (e.g., see 302a) extending laterally from the second lateral end 328 toward the first lateral end 326. A guide ridge (e.g., see 306) may extend laterally connecting the first flat rail surface to the second flat rail surface.

This guide ridge may include a convex arcuate surface (e.g., see 312) that defines the first vertical extremity 330. In some embodiments, a first concave arcuate surface 334 may be disposed vertically below the first flat rail surface (e.g., see 302), and that defines the second vertical extremity 332. Alternatively, a first parallel flat surface 344 (see FIG. 7) may be disposed vertically below the first flat rail surface.

In like fashion, a second concave arcuate surface may be disposed vertically below the second flat rail surface (e.g., see 302a) and that is coextensive with the first concave arcuate surface. That is to say, they would form the same cylindrical surface if not interrupted by the guiding ridge. Alternatively, another parallel flat surface 344a (see FIG. 7) may be disposed vertically below the second flat rail surface that is coplanar with its counterpart (see 344).

In FIG. 5, the at least partial flat body defines a groove (e.g., see 304) that is interposed laterally between the first concave arcuate surface 334 and the second concave arcuate surface 334a (or the corresponding parallel flat surfaces 334 and 334a). This groove may also be disposed vertically underneath the guide ridge, and the guide ridge (e.g., see 306) may define a plurality of fastener receiving apertures (e.g., see 308) that extend completely vertically through the guide ridge. This may not be the case for other embodiments of the present disclosure.

Another idler segment 300 constructed according to another embodiment of the present disclosure for use with the idler assembly 200 may be characterized as follows.

Looking at FIGS. 5 and 6, the idler segment 300 may comprise at least a partial body of revolution. So called, since at least a part of the body may be constructed by rotating geometry using CAD (computer aided drafting) or machining the body about an axis of rotation. Thus, this body may define a circumferential direction (e.g., may be the same as 208 when assembled), a radial direction (e.g., see 206), and an axis of rotation (e.g., see 204).

A guide ridge (e.g., see 306) may extend axially, radially, and circumferentially to the circumferential extremities (e.g., see 322 and 324) of the idler segment 300. A first planar contact surface (e.g., see 302) may extend axially from the guide ridge to an axial extremity (e.g., see 326) of the idler segment (300), and a second planar contact surface (e.g., see 302a) may extend axially from the guide ridge to the opposite axial extremity (e.g., see 328).

In certain embodiments of the present disclosure, the first planar contact surface (e.g., see 302) comprises a first material zone 336 (see FIG. 6) with a first property, and a remaining portion of the at least partial body of revolution comprises a second material zone 338 with a second property that is different than the first property.

For example, the first property may be a first material, and the second property may be a second material that is different than the first. Or, the first property is a coating, and the second property is a lack of coating. Or, the first property is a first material hardness, and the second property is a second material hardness that is different than the first material hardness, etc.

Focusing on FIG. 6, the second planar contact surface may include a third material zone 336a that has a third property that is the same as the first property of the first material zone of the first planar contact surface.

In FIG. 5, the guide ridge (e.g., see 306) may further comprise a radially outer circumferential surface (e.g., see 312), a first radially extending surface 340 (may be planar or conical) connecting the first planar contact surface (e.g., see 302) to the radially outer circumferential surface, a second radially extending surface 342 (may be planar or conical) connecting the second planar contact surface (e.g., see 302a) to radially outer circumferential surface (e.g., see 312).

The first planar contact surface, the first radially extending surface, the radially outer circumferential surface, the second radially extending surface, and the second planar contact surface may share the same first material zone 336 that extends axially, and circumferentially to include an entirety of the first planar contact surface, the first radially extending surface, the radially outer circumferential surface, the second radially extending surface, and the second planar contact surface in some embodiments of the present disclosure.

Any of the aforementioned features may be differently configured or dimensioned than what has been specifically described herein in various embodiments of the present disclosure.

For many embodiments, the idler segment and/or hub may be cast using iron, grey-iron, steel or other suitable materials. Other manufacturing processes may be used such as any type of machining, forging, etc. For example, steel or “tough steel” may be used to create the idler segments. Idler segments may also be coated, heat treated, etc. to provide suitable characteristics for various applications.

### INDUSTRIAL APPLICABILITY

In practice, an idler assembly, an idler segment, and an undercarriage assembly according to any embodiment described herein may be sold, bought, manufactured or otherwise obtained in an OEM (original equipment manufacturer) or after-market context.

The various embodiments of the idler segments may help to share the loads between adjacent segments, reducing the load borne by any single segment or its fasteners, etc. Also, the width of the idler segments may be varied to provide versatility to accommodate different track chain assemblies.

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. An idler assembly comprising:
a cylindrical hub defining an axis of rotation, a radial direction, and a circumferential direction, and including a stepped circumferential surface having a first radially inner face, and a radially outer cylindrical face, and defining a plurality of mounting holes extending radially into the radially outer cylindrical face, the cylindrical hub having a first set of metallurgical properties;
a first idler segment including
an at least partially flat body having
a first planar chain link contacting surface that includes a second set of metallurgical properties that is different than the first set of metallurgical properties of the cylindrical hub.

2. The idler assembly of claim 1 wherein a difference between the first set of metallurgical properties of the cylindrical hub, and the second set of metallurgical properties of the first idler segment includes at least one of the following: a material composition, a hardness, a coating, or a distribution of the material composition, the hardness, or the coating.

3. The idler assembly of claim 1 wherein the stepped circumferential surface forms a spline, and the first idler segment defines a spline receiving groove, and the spline of the cylindrical hub is disposed in the spline receiving groove of the first idler segment, and the first idler segment includes a guiding ridge that defines a plurality of mounting apertures that extend radially through the first idler segment, and are aligned circumferentially, and axially with the plurality of mounting holes.

4. The idler assembly of claim 3 wherein the first radially inner face of the cylindrical hub is a convex arcuate surface.

5. The idler assembly of claim 4 wherein the stepped circumferential surface of the cylindrical hub includes a second radially inner face, and the first idler segment includes a second planar chain link contacting surface that is in a plane with the first planar chain link contacting surface.

6. The idler assembly of claim 5 wherein the second radially inner face of the cylindrical hub is also a convex arcuate surface.

7. The idler assembly of claim 6 wherein the guiding ridge includes a convex surface that defines a radial extremity of the first idler segment.

8. The idlers assembly of claim 7 comprises a plurality of idler segments that are identically configured as the first idler segment.

9. The idler assembly of claim 8 wherein the first and the second radially inner faces are concentric with the radially outer cylindrical surface.

10. The sprocket assembly of claim 2 wherein the first idler segment has a different material composition than the cylindrical hub.

11. An idler segment comprising:
an at least partial flat body including defining a longitudinal direction, a lateral direction that is perpendicular to the longitudinal direction, and a vertical direction that is perpendicular to the lateral direction and the vertical direction, the body further defining a first longitudinal end, a second longitudinal end, a first lateral end, a second lateral end, a first vertical extremity, and a second vertical extremity, the at least partial flat body includes
a first flat rail surface extending laterally from the first lateral end toward the second lateral end;
a second flat rail surface extending laterally from the second lateral end toward the first lateral end; and
a guide ridge laterally connecting the first flat rail surface to the second flat rail surface.

12. The idler segment of claim 11 wherein the guide ridge includes a convex arcuate surface that defines the first vertical extremity.

13. The idler segment of claim 12 further comprising a first concave arcuate surface or a first parallel flat surface that is disposed vertically below the first flat rail surface, and that defines the second vertical extremity.

14. The idler segment of claim 13 further comprising a second concave arcuate surface or a second parallel flat surface that is disposed vertically below the second flat rail surface and that is coextensive with the first concave arcuate surface.

15. The idler segment of claim 14 wherein the at least partial flat body defines a groove interposed laterally between the first concave arcuate surface and the second concave arcuate surface, the groove also being disposed vertically underneath the guide ridge, and the guide ridge defines a plurality of fastener receiver apertures that extend completely vertically through the guide ridge.

16. An idler segment comprising:
at least a partial body of revolution including defining a circumferential direction, a radial direction, and an axis of rotation, the at least partial body of revolution including a guide ridge extending axially, radially, and circumferentially;
a first planar contact surface extending axially from the guide ridge; and
a second planar contact surface extending axially from the guide ridge;
wherein the first planar contact surface comprises a first material zone with a first property, and a remaining portion of the at least partial body of revolution comprises a second material zone with a second property that is different than the first property.

17. The idler segment of claim 16 wherein the first property is a first material, and the second property is a second material that is different than the first, or the first property is a coating, and the second property is a lack of coating, or the first property is a first material hardness, and the second property is a second material hardness that is different than the first material hardness.

18. The idler segment of claim 16 wherein the second planar contact surface includes a third material zone that has a third property that is the same as the first property of the first material zone of the first planar contact surface.

19. The idler segment of claim 16 wherein the guide ridge further comprises a radially outer circumferential surface, a first radially extending surface connecting the first planar contact surface to the radially outer circumferential surface, a second radially extending surface connecting the second planar contact surface to the radially outer circumferential surface.

20. The idler segment of claim 19 wherein the first planar contact surface, the first radially extending surface, the radially outer circumferential surface, the second radially extending surface, and the second planar contact surface share the same first material zone that extends axially, and circumferentially to include an entirety of the first planar contact surface, the first radially extending surface, the radially outer circumferential surface, the second radially extending surface, and the second planar contact surface.
